(19) United States
(12) Patent Application Publication
(10) Pub. No.: US 2006/0209167 A1
(43) Pub. Date: Sep. 21, 2006

(54) Color image forming apparatus

(75) Inventor: Takashi Shiraishi, Kawasaki-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/083,102

(22) Filed: Mar. 18, 2005

(51) Int. Cl. B41J 2/435

(52) U.S. Cl. 347/232

(57) ABSTRACT

A color image forming apparatus has a color mode for color printing and a monochrome mode for printing at a higher speed than the printing speed of the color mode.

The color image forming apparatus has mirrors 33, 35 and 37 that reflect the laser beams in order to guide the laser beams to optimum positions when the laser beams are guided from light sources (LD) to photoconductor drums 58, and in an optical system for the monochrome mode, the mirrors whose number is smaller than that in the other optical systems are arranged.

### BACKGROUND OF THE INVENTION

1. Field of the Invention

The present invention relates to a color image forming apparatus such as a color laser printer or a color digital copying machine.

2. Description of the Related Art

A color image forming apparatus is disclosed in, for example, Japanese Patent Application Laid-Open No. 2002-278228. The number of mirrors for reflecting an optical path of a writing section with a larger recording amount for forming an image is set to be smaller than a number of mirrors of the other writing section with a smaller recording amount, so that attenuation of a beam power in the writing section with larger recording amount is reduced. As a result, a light emitting power of the writing section with larger recording amount is reduced, so that the deformation (expansion or the like) due to heat generation is suppressed. This is because when the heat generation is great, respective parts expand, positions of the parts such as mirrors and lenses in the writing sections shift, thereby causing color shift in color images. When the light emitting power is reduced, this problem can be prevented.

In general, in image forming apparatuses such as color copying machines, one restriction on a speed in the case of color printing is fixing of toner. In the case of the color printing, since many layers of toner is superposed on paper, a load on the fixing increases, and when the printing is tried to be carried out with a not more than predetermined electric power (W (watt)), a printing speed becomes slower than the case of monochrome.

Under the same constitution, when the monochrome (for example, black) printing is carried out, the load on a fixing portion is reduced, and thus an upper limit of the printing speed with respect to the fixing becomes higher than the case of the color printing. When the printing speed is increased accordingly, speeds of a signal processing system and driving should be increased. It is required to increase the power on a photoconductor even in a writing scanning optical system. For example, in order to multiply the printing speed by a, the power on the photoconductor should be multiplied by a.

Conventionally, in the case where it is highly noted that image forming characteristics of the writing optical systems are made to be uniform, normally, an image forming apparatus is designed so that (1) a light source LD of light sources (LD) for respective colors which requires the highest power is used for all the light sources, or (2) a plurality of light sources for monochrome printing are provided so as to make a multibeam, thereby securing the power.

When the cost is highly noted, the apparatus is designed so that (3) only light sources for color printing have high power.

The above conventional technology, however, has the following problems.

(1) The effect produced by reducing the attenuation of the beam power in the writing section with larger recording amount is not positively utilized.

(2) In the conventional system, the cost becomes high in all the design forms. Further, in the case of the form (3) where the percentage that the cost becomes high is the lowest, the LDs which are different from those for color printing are used for monochrome printing, radiation angles, wavelengths and driving characteristics of the LDs as the light sources vary. For this reason, the image forming characteristics (a beam diameter and intensity distribution on an image surface), fθ characteristics, bent of a scanning line and a plane tilt compensation effect of only light beams for monochrome printing are different from those of the other light beams, and thus it is difficult to balance image printing processes for respective colors and an image processing at the time of the color printing.

### SUMMARY OF THE INVENTION

In an image forming apparatus (1 pass color machine) having a color mode for printing with multicolors and a monochrome mode whose printing speed is higher than the color mode, the number of mirrors to be arranged on an optical path between the light source of the light beam for writing with monochrome and a surface to be scanned is set to be smaller than the number of mirrors to be arranged on optical paths between light sources of light beams for the other colors and the surface to be scanned. As a result, a maximum power of the light sources for monochrome is suppressed small.

### BRIEF DESCRIPTION OF THE DRAWINGS

FIG. 1 is a schematic constitutional diagram illustrating an image forming apparatus;

FIG. 2 is a schematic side view illustrating an optical scanning device;

FIG. 3 is a schematic plan view illustrating the optical scanning device;

FIG. 4 is a pattern diagram illustrating transmission and reflection states of light in the optical scanning device;

FIG. 5 is a schematic plan view illustrating the optical scanning device according to a first modified example;

FIG. 6 is a pattern diagram illustrating the transmission and reflection states of the light in the optical scanning device of FIG. 5;

FIG. 7 is a schematic plan view illustrating the optical scanning device according to a second modified example; and

FIG. 8 is a pattern diagram illustrating the transmission and the reflection states of the light in the optical scanning device of FIG. 7.

### DESCRIPTION OF THE PREFERRED EMBODIMENT

A color image forming apparatus according to the preferred embodiment of the present invention is explained below.

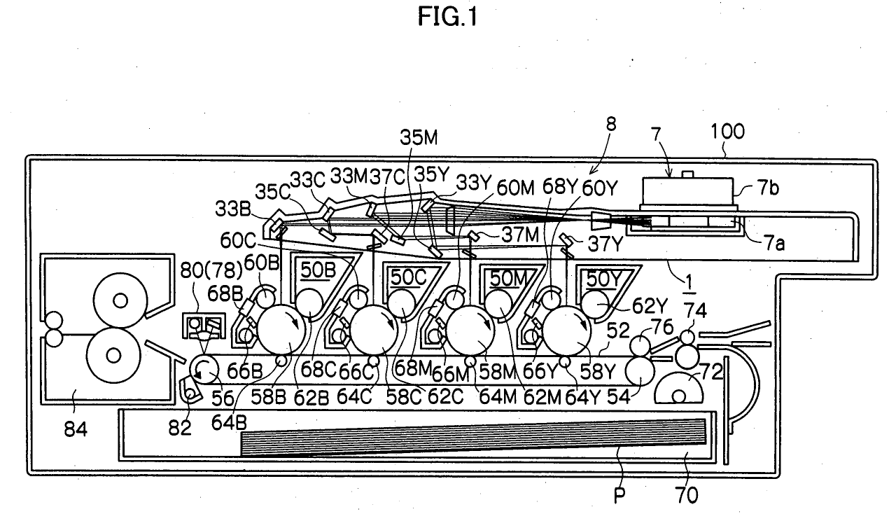

The color image forming apparatus is constituted as shown in FIG. 1. In the color image forming apparatus, normally an image is formed by using four kinds of image data which are separated according to respective color components of Y, namely, yellow, M, namely, magenta, C, namely, cyan and B, namely black (black is used for inking). In this color image forming apparatus, since four sets of various devices that form images according to the respective color components correspondingly to Y, M, C and B are used, Y, M, C and B are added to reference numerals, so that the image data for the respective color components and the devices related with them are identified.

As shown in FIG. 1, the color image forming apparatus 100 has first through fourth image forming sections 50Y, 50M, 50C and 50B that form images according to the separated color components Y, M, C and B.

The image forming sections 50 (Y, M, C and B) are arranged in series below an optical scanning device 1 in order of 50Y, 50M, 50C and 50B correspondingly to positions where laser beams L (Y, M, C and B) corresponding to the color component images are emitted via third mirrors 37Y, 37M and 37C and a first mirror 33B of the optical scanning device 1.

A transport belt 52 that transports transfer materials on which images formed by the image forming sections 50 (Y, M, C and B) are transferred is arranged below the image forming sections 50 (Y, M, C and B).

The transport belt 52 is bridged between a belt driving roller 56 and a tension roller 54 to be rotated to a direction of an arrow by a motor, not shown, and is rotated at a predetermined speed to a direction where the belt driving roller 56 rotates.

The image forming sections 50 (Y, M, C and B), formed in a cylindrical drum shape, are rotatably attached in a direction of an arrow. The image forming sections 50 (Y, M, C and B) have photoconductor drums 58Y, 58M, 58C and 58B on which electrostatic latent images corresponding to images are formed.

The photoconductor drums 58Y, 58M, 58C and 58B are rotated by a driving motor (not shown), but its rotational speed can be adjusted. That is to say, the rotational speeds of all the photoconductor drums 58Y, 58M, 58C and 58B to be used in the color mode, and the photoconductor drum 58B to be used in the monochrome mode can be adjusted. The rotational speed of the photoconductor drum in the monochrome mode is set to be faster than the rotational speed of the photoconductor drums in the color mode according to a ratio of optical efficiency. As a result, the rotational speed of the photoconductor drum 58B can be changed in the monochrome mode and the color mode.

The following three patterns for adjusting the rotational speed are present. One pattern is that all the photoconductor drums 58Y, 58M, 58C and 58B are driven by one driving motor. Another pattern is that the photoconductor drums 58Y, 58M and 58C are driven by one driving motor, and the photoconductor drum 58B is driven by one driving motor. The other pattern is that all the photoconductor drums 58Y, 58M, 58C and 58B are driven individually by four driving motors. As a result, in the color mode, all the photoconductor drums 58Y, 58M, 58C and 58B are rotated at a constant speed. In the monochrome mode, the photoconductor drums 58Y, 58M and 58C are stopped, and only the photoconductor drum 58B is rotated at a higher speed than the other drums. When all the photoconductor drums 58Y, 58M, 58C and 58B are driven by one driving motor, a mechanism that tilts the transport belt 52 is provided. Due to the mechanism that tilts the transport belt 52, in the case of the color mode, the transport belt 52 comes in contact with all the photoconductor drums 58Y, 58M, 58C and 58B to rotate them at the constant speed. In the case of the monochrome mode, the transport belt 52 comes in contact with only the photoconductor drum 58B to rotate it at a higher speed than the color mode. Specifically, an elevating mechanism that sends up and down the tension roller 54 is provided. The elevating mechanism sends up the tension roller 54 to be in contact with all the photoconductor drums 58Y, 58M, 58C and 58B, and sends down the tension roller 54 to be in contact with only the photoconductor drum 58B. Also in the case where the photoconductor drums 58Y, 58B and 58C are suspended in the monochrome mode, the elevating mechanism sends up and down the tension roller 54 as desired. Further, the emission of the laser beams to the photoconductor drums 58Y, 58M and 58C are stopped and thus the formation of latent images is suspended, so that the photoconductor drums 58Y, 58M and 58C may be idled. The rotational speeds of the drums are adjusted so that the drums rotate normally in the color mode and at a high speed in the monochrome mode.

Charging devices 60Y, 60M, 60C and 60B, developing devices 62Y, 62M, 62C and 62B, transfer devices 64Y, 64M, 64C and 64B, cleaners 66 (Y, M, C and B), and static eliminating devices 68 (Y, M, C and B) are arranged around the photoconductor drums 58 (Y, M, C and B), respectively, along the rotational direction of the photoconductor drums 58 (Y, M, C and B). The charging devices 60Y, 60M, 60C and 60B provide predetermined electric potentials to the surfaces of the photoconductor drums 58 (Y, M, C and B). The developing devices 62Y, 62M, 62 C and 62B develop an electrostatic latent images by providing toner of colors corresponding to the latent images formed on the photoconductor drums 58 (Y, M, C and B). The transfer devices 64Y, 64M, 64C and 64B are opposed to the photoconductor drums 58 (Y, M, C and B), respectively, with the transport belt 52 intervening between the transfer devices 64 (Y, M, C and B) and the photoconductor drums 58 (Y, M, C and B), and transfer toner images of the photoconductor drums 58 (Y, M, C and B) onto the transport belt 52 or a recording medium to be transported via the transport belt 52, namely, recording paper P. After the toner images are transferred by the transfer devices 64 (Y, M, C and B), the cleaners 66 (Y, M, C and B) eliminate residual toner on the photoconductor drums 58 (Y, M, C and B). The discharge devices 68 (Y, M, C and B) eliminate residual electric potentials on the photoconductor drums 58 (Y, M, C and B) after the toner images are transferred by the transfer devices 64 (Y, M, C and B).

A paper cassette 70 that houses recording media, namely, the paper P for the images formed by the image forming sections 50 (Y, M, C and B) being transferred is arranged below the transfer belt 52.

A pick-up roller 72, which is formed roughly in a semilunar shape and takes out the paper P housed in the paper cassette 70 one by one from the top, is arranged at one end of the paper cassette 70 on a side in the vicinity of the tension roller 54.

A registration roller 74, which aligns a forward end of one piece of paper P taken out from the cassette 70 with a forward end of the toner image formed on the photoconductor drum 58B of the image forming section 50B (black), is arranged between the pick-up roller 72 and the tension roller 54.

An adsorption roller 76 is provided between the registration roller 74 and the first image forming section 50Y on an outer periphery of the tension roller 54 across the transport belt 52. The adsorption roller 76 provides a predetermined electrostatic absorptive power to one piece of paper P transported at predetermined timing via the registration roller 72.

Registration sensors 78 and 80, which detect a position of the image formed on the transport belt 52 or the paper P transported by the transport belt 52, are arranged at one end of the transport belt 52 in the vicinity of the belt driving roller 56 substantially on the outer periphery of the belt driving roller 56 across the transport belt 52 with a predetermined distance being provided in an axial direction of the belt driving roller 56.

A transport belt cleaner 82, which eliminates toner or paper waste of the paper P and the like adhering to the transport belt 52, is arranged on the transport belt 52 corresponding to the outer periphery of the belt driving roller 56.

A fixing device 84, which fixes the toner image transferred to the paper P onto the paper P, is arranged in a lower-stream direction where the paper P transported via the transport belt 52 is separated from the driving roller 56 and is further transported.

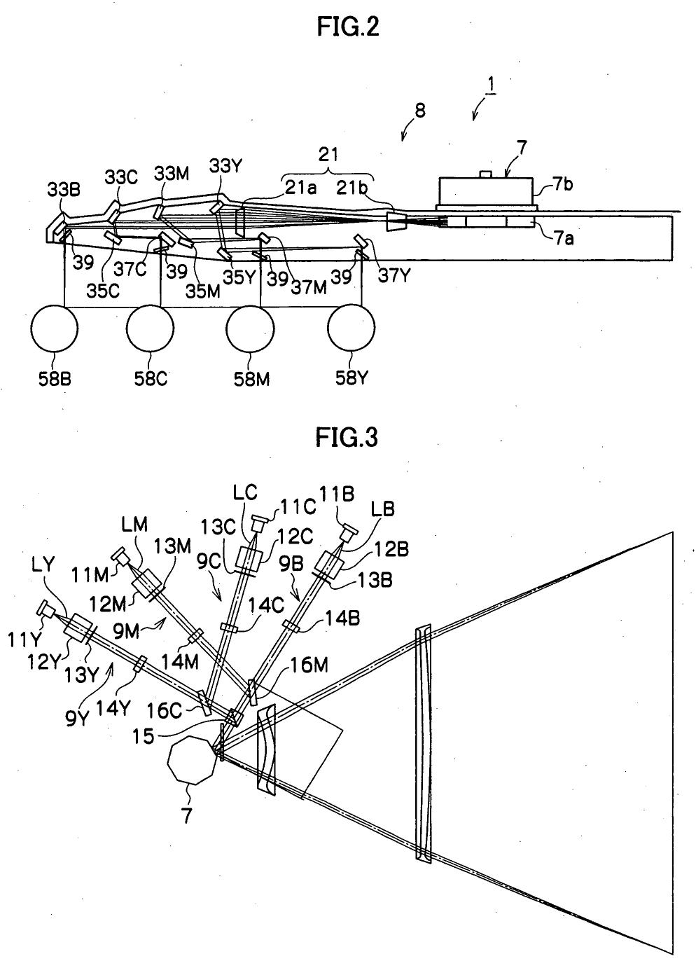

The optical scanning device 1 to be used in the color image forming apparatus 100 is explained below with reference to FIGS. 1 and 2.

As shown in the drawings, the optical scanning device 1 is a device for scanning and emitting the laser beams emitted from the laser diodes (LD) as the light sources to the photoconductor drums (the photoconductor drums 58Y, 58M, 58C and 58B of the first to the fourth image forming sections 50Y, 50M, 50C and 50B) as the image surfaces arranged in predetermined positions. The optical scanning device 1 has an optical deflecting device 7 that deflects the laser beams towards the predetermined positions of the photoconductor drums 58Y, 58M, 58C and 58B at a predetermined linear velocity, a post-deflection optical system 8 that is provided between the optical deflecting device 7 and the image surfaces (photoconductor drums 58Y, 58M, 58C and 58B), and a pre-deflection optical system 9 that is provided between the light sources and the optical deflecting device 7. A direction where the laser beams are deflected by the optical deflecting device 7 is a main scanning direction.

The optical deflecting device 7 has a polygon mirror main body 7a in which an 8 surface flat mirrors are arranged into a regular polygon form, and a motor 7b that rotates the polygon mirror main body 7a to the main scanning direction at a predetermined speed.

The post-deflection optical system 8 is composed of an image forming lens group 21, and mirrors 33, 35 and 37. The image forming lens group 21 is composed of first and second image forming lenses 21a and 21b that provide predetermined optical characteristics to the laser beams deflected to the predetermined direction by the reflection surface of the optical deflecting device 7.

The mirrors 33, 35 and 37 are mirrors that guide the laser beams reflected by the optical deflecting device 7 to the photoconductor drums 58Y, 58M, 58C and 58B, and have different constitutions according to the respective colors.

For yellow, three mirrors 33Y, 35Y and 37Y are provided. The first mirror 33Y is arranged in a position which is the closest to the image forming lens group 21 and on the most upper stream side of the optical path in the side view of FIG. 2. As a result, the laser beam LY which is positioned on the most upper stream side is reflected to the photoconductor drum side (the scanned surface side). The second mirror 35Y is positioned on the photoconductor drum side (the scanned surface side) of the first mirror 33Y and receives the laser beam LY reflected by the first mirror 33Y. The third mirror 37Y is positioned on the photoconductor drum 58Y side, and reflects the laser beam LY reflected to a direction of the third mirror 37Y by the second mirror 35Y towards the photoconductor drum 58Y.

For magenta, three mirrors 33M, 35M and 37M are provided. The first mirror 33M is provided in a position which is adjacent to the mirror 33Y for yellow and is on the upper stream side of the optical path and next to the first mirror 33Y for yellow in the side view of FIG. 2. As a result, the first mirror 33M reflects the laser beam LM just below the laser beam LY downward. The second mirror 35M is positioned on the photoconductor drum side (the scanned surface side) of the first mirror 33M and receives the laser beam LM reflected by the first mirror 33M. The third mirror 37M is positioned on the photoconductor drum 58M side and reflects the laser beam LM reflected to the direction of the third mirror 37M by the second mirror 35M towards the photoconductor drum 58M.

For cyan, three mirrors 33C, 35C and 37C are provided. The first mirror 33C is arranged in a position which is adjacent to the mirror 33M for magenta and is on the upper stream side of the optical path and next to the mirror 33M for magenta in side view of FIG. 2. As a result, the first mirror 33C reflects the laser beam LC just below the laser beam LM to the photoconductor drum side (the scanned surface side). The second mirror 35C is positioned below the first mirror 33C, and receives the laser beam LC reflected by the first mirror 33C. The third mirror 37C is positioned on the photoconductor drum 58C side, and reflects the laser beam LC reflected to the direction of the third mirror 37C by the second mirror 35C towards the photoconductor drum 58C.

For black, one mirror 33B is provided. The mirror 33B is arranged in a position which is adjacent to the mirror 33C for cyan and on the photoconductor drum 58B side in the side view of FIG. 2. The laser beam LB is adjusted so as to pass through the mirrors 33Y, 35Y, 37Y, 33M, 35M, 37M, 33C, 35C and 37C and reach the mirror 33B. As a result, only one mirror 33B reflects the laser beam LB directly towards the photoconductor drum 58B.

Dust-proof glasses 39B, 39Y, 39C and 39M are provided onto the mirrors 33B, 37C, 37M and 37Y on the side of the photoconductor drums 58Y, 58M, 58C and 58B, respectively.

The laser beams LY, LM, LC and LB are emitted to the photoconductor drums 58Y, 58M, 58C and 58B from between the charging devices 60 (Y, M, C and B) and the developing devices 62 (Y, M, C and B), respectively.

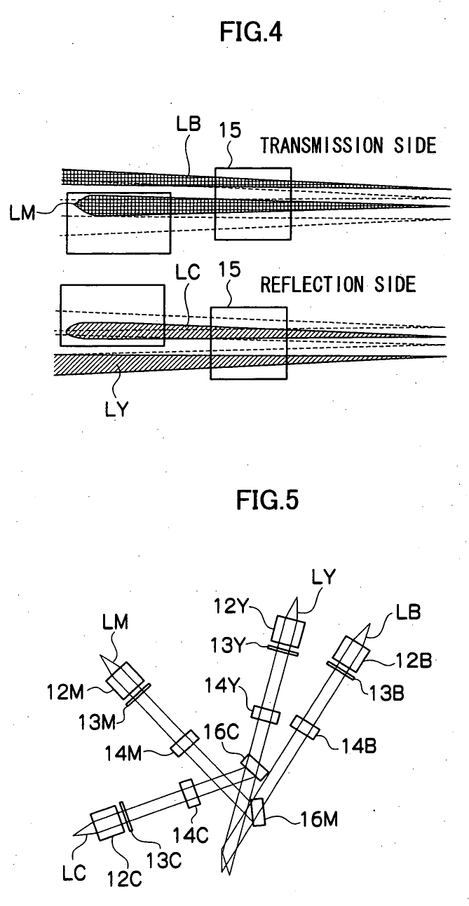

The pre-deflection optical system 9 is constituted as shown in FIGS. 3 and 4.

As the light sources of the laser beams to enter the pre-deflection optical system 9, first to fourth LDs (laser diodes) 11Y, 11M, 11C and 11B are provided. The LDs 11Y, 11M, 11C and 11B emit the laser beams LY, LM, LC and LB to be guided to the photoconductor drums 58Y, 58M, 58C and 58B. The first LD 11Y is a laser diode for yellow that emits the laser beam corresponding to the yellow image. The second LD 11M is a laser diode for magenta that emits the laser beam corresponding to the magnate image. The third LD 11C is a laser diode for cyan that emits the laser beam corresponding to the cyan image. The LDs 11Y, 11M and 11C give the same outputs.

The fourth LD 11B is a laser diode for black that emits the laser beam corresponding to the black image. The fourth LD 11B is composed of an output variable laser diode. As a result, an output power on the photoconductor from the fourth LD 11B is adjusted so as to be larger in the monochrome mode than the power on the photoconductor by the other LDs similarly to the color mode. The fourth LD 11B may be a laser diode in which light emitting time is adjusted according to a pulse width and the output is changed instead of the laser diode in which the light emission power is variable.

Four sets of pre-deflection optical systems 9Y, 9M, 9C and 9B, which adjust beam shapes of the laser beams LY, LM, LC and LB from the LDS 11Y, 11M, 11C and 11B into a predetermined shape and allow them to enter the optical deflection device 7, are arranged between the first to the fourth LDs 11Y, lM, 11C and 11B and the optical deflecting device 7.

The first pre-deflection optical system 9Y is composed of a finite focal lens 12Y, a diaphragm 13Y, a cylinder lens 14Y and a beam splitter 15.

The finite focal lens 12Y reduces, or converges a divergence angle of divergent ray from the LD 11Y. The diaphragm 13Y adjusts the sectional beam shape of the laser beam LY into a predetermined shape. The cylinder lens 14Y provides predetermined convergence to a sub-scanning direction. The beam splitter 15 turns the laser beam LY from the cylinder lens 14Y towards the optical deflecting device 7.

The second pre-deflection optical system 9M is composed of a finite focal lens 12M, a diaphragm 13M, a cylinder lens 14M and a mirror 16M. The finite focal lens 12M, the diaphragm 13M and the cylinder lens 14M are similar to those of the first pre-deflection optical system 9Y. The mirror 16M reflects the laser beam LM emitted from the cylinder lens 14M towards the optical deflecting device 7. The mirror 16M is arranged above the optical path of the laser beam LB.

The third pre-deflection optical system 9C is composed of a finite focal lens 12C, a diaphragm 13C, a cylinder lens 14C, a mirror 16C and a beam splitter 15. The finite focal lens 12C, the diaphragm 13C, the cylinder lens 14C and the beam splitter 15 are similar to those of the first pre-deflection optical system 9Y. The mirror 16C reflects the laser beam LC emitted from the cylinder lens 14C. The laser beam LC reflected by the mirror 16C enters the optical deflecting device 7 via the beam splitter 15.

The fourth pre-deflection optical system 9B is composed of a finite focal lens 12B, a diaphragm 13B and a cylinder lens 14B. The finite focal lens 12B, the diaphragm 13B and the cylinder lens 14B are similar to those of the first pre-deflection optical system 9Y. In the fourth pre-deflection optical system 9B, the laser beam LB directly enters the optical deflecting device 7 without via the mirror.

A half mirror may be used instead of the beam splitter 15.

When the post-deflection optical system 8 and the pre-deflection optical system 9 are constituted as mentioned above, the laser beam LB is not reflected and directly enters the optical deflecting device 7 by the pre-deflection optical system 9B on the optical path for a black light beam. After being reflected by the optical deflecting device 7, the laser beam LB is reflected only once by the mirror 33B in the post-deflection optical system 8. For this reason, the number of the mirrors on the optical path for black beam is smaller than that on the optical paths for the other colors, and thus the optical efficiency of the black light beam can be higher than the optical efficiency of the light beams for the other colors.

When the printing speed is multiplied by β, a speed of the driving system motor, a rotational speed of a polygon motor and an image frequency are multiplied by β, so that the entire setting is changed. At this time, however, the power of the laser beams need to be also changed. Specifically, the power of the LD to be used for the monochrome printing needs to be β times as high as the power of the LDs to be used for the multicolor printing. This is not the power of the light sources but the power of the laser beams which reach the photo conductor drums 58. For this reason, when the optical efficiency in the post-deflection optical system 8 and the pre-deflection optical system 9 is high, the power of the light sources does not have to be increased so much. For this reason, the optical efficiency is important. The optical efficiency in the pre-deflection optical system 9 is explained below.

The transmission and the reflection efficiency in the beam splitter 15 are approximately uniform. In the case of a half mirror type, the transmission and the reflectance are approximately 50%. In the case of the deflecting beam splitter type, the transmission and the reflectance are nearly 100%.

When the reflectance of the mirror in the pre-deflection optical system 9 is designated by r₀ and the reflectance of the mirror in the post-deflection optical system 8 is designated by r₁, one mirror for black light beam is present in the post-deflection optical system 8, three mirrors for yellow light beam are present in the post-deflection optical system 8, one mirror for magenta light beam is present in the pre-deflection optical system 9, three mirrors for magenta light beam are present in the post-deflection optical system 8, one mirror for cyan light beam is present in the pre-deflection optical system 9, and three mirrors for cyan light beam are present in the post-deflection optical system 8. For this reason, the optical efficiency becomes as follows:

(1) efficiency by the mirror for the black light beam: r₁;

(2) efficiency by the mirror for the yellow light beam: r₁³:

(3) efficiency by the mirror for the magenta light beam: r₀×r₁³: and

(4) efficiency by the mirror for the cyan light beams: r₀×r₁³.

As a result, when the mirror efficiency is 0.8 to 0.9 which is normal, the following results are obtained:

| | | | |
|---|---|---|---|
| | Mirror reflectance | 0.8 | 0.9 |
| Optical efficiency by the | Black light beam | 0.8 | 0.9 |
| mirror | Yellow light beam | 0.512 | 0.729 |
| | Magenta and | 0.4096 | 0.6561 |
| | cyan light beams | | |

| | | |
|---|---|---|
| Amount of black light beam/ | 1.953125 | 1.371742 |
| amount of magenta and | | |
| cyan light beam | | |

As is clear from this table, even when the monochrome light beam whose maximum exposing amount in the light source is the same as the color light beams is used, the speed can be 1.95 times at the mirror reflectance of 80%, and 1.37 times at the mirror reflectance of 90%.

Further, when only the mirror for the monochrome light beam is subject to reflective coating or the like so that the mirror reflectance is about 0.98, the following results are obtained:

| | | | |
|---|---|---|---|
| | Mirror reflectance | 0.8 | 0.9 |
| Optical efficiency by the | Black light beam | 0.98 | 0.98 |
| mirror | Yellow light beam | 0.512 | 0.729 |
| | Magenta and | 0.4096 | 0.6561 |
| | cyan light beams | | |

| | | |
|---|---|---|
| Amount of black light beam/ | 2.392578 | 1.493675 |
| amount of magenta and | | |
| cyan light beam | | |

As is clear from this table, even in the case where the monochrome light beam whose maximum exposing amount in the light source is the same as the color light beams is used, the speed can be 2.4 times at the mirror reflectance of 80% for light beams other than the black light beam and 1.5 times at the mirror reflectance of 90% for the light beams other than the black light beam.

It is not always necessary to set the light emitting power of the light sources for the color light beams and the light emitting power of the light source for the black light beam at the time of the monochrome printing so that they are equal with each other, and thus the difference between the color printing speed and the monochrome printing speed can be larger.

[First Modified Example]

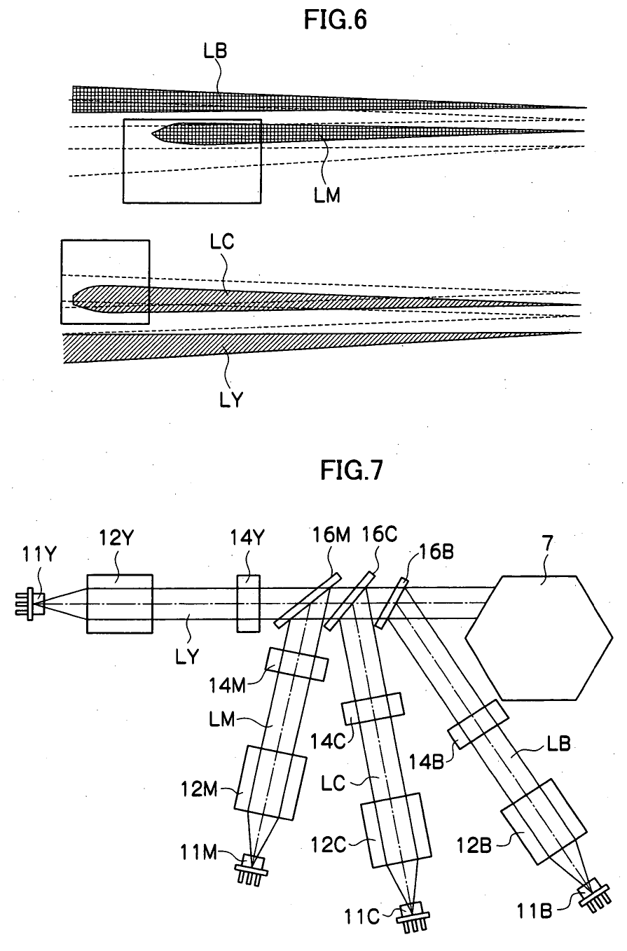

As shown in FIGS. 5 and 6, in the pre-deflection optical system, the beam splitter 15 (or half mirror) is not used, but the optical path may be shifted and the light beams are allowed to enter the optical deflecting device 7. The members composing the pre-deflection optical system shown in FIG. 5 are the same as those in the pre-deflection optical system 9 shown in FIG. 3 except that the beam splitter 15 is not provided. The members arranged on the optical paths of the laser beams LM and LB and their positions are the same as those in FIGS. 3 and 5. The position of the laser beam LY is changed to be in the vicinity of the laser beam LB. As a result, the laser beam LY directly enters the optical deflecting device 7 without being reflected. The mirror 16C is provided on the optical path of the laser beam LY, and the laser beam LC is guided to the optical deflecting device 7.

This case can also produce the same effect as the above embodiment.

[Second Modified Example]

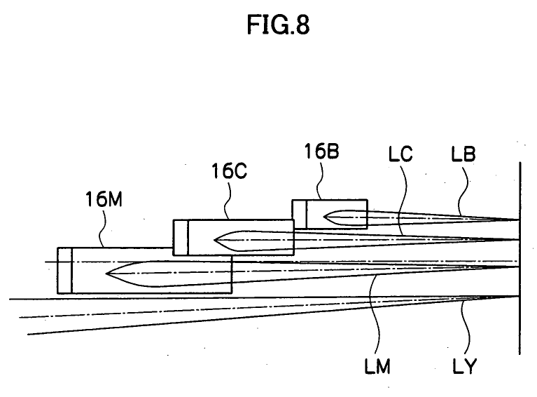

The efficiency ratio falls, but even when the mirrors are arranged in the pre-deflection optical system 9 as shown in FIGS. 7 and 8, a certain effect can be produced.

The mirrors are provided so that the yellow laser beam LY directly enters the optical deflecting device 7. The three mirrors 16M, 16C and 16B are arranged on the optical path of the laser beams LY, and the mirrors 16M, 16C and 16B reflect the magenta laser beam LM, the cyan laser beam LC and the black laser beam LB so as to allow them to enter the optical deflecting device 7.

In this case, the efficiency ratio is as shown in the following table. Even when the monochrome light beam whose maximum exposing amount is the same as the color light beams is used, the speed can be 1.5 times at the mirror reflectance of 80% for the light beams other than the black light beam and 1.2 times at the mirror reflectance of 90% for the light beams other than the black light beam.

| | | | |
|---|---|---|---|
| | Mirror reflectance | 0.8 | 0.9 |
| Optical efficiency by the | Black light beam | 0.64 | 0.81 |
| mirror | Yellow light beam | 0.512 | 0.729 |
| | Magenta and | 0.4096 | 0.6561 |
| | cyan light beams | | |

| | | |
|---|---|---|
| Amount of black light beam/ | 1.5625 | 1.234568 |
| amount of magenta and | | |
| cyan light beam | | |

As detailed above, the present invention produces the following effects.

If the optical efficiency [(the power of the beams on the image forming surface)/(the power of the beams on the light emitting portion)] from the light sources to the image surfaces for the monochrome printing can be increased, even when the same light source is used, the speed of the monochrome printing can be increased. For example, when [(the optical efficiency of the writing optical system for the monochrome printing)/(the optical efficiency of the writing optical system for the other color printing)=β], even if all the light sources emit light beams with the uniform power, as to the speed of the monochrome printing, the light amount can be β time as large as the color printing. Since the power of LD to be used for the monochrome printing becomes 1/β of the other colors at the time of the color printing, rise characteristics and wavelengths are slightly different, but this does not become a problem on the image.

As a result, the following effect is produced in relation to the conventional technique.

(1) Since the LD of the light sources (LDS) corresponding to the respective colors which requires the highest power is used for all light sources in the conventional technique, but in the present invention, since the maximum power of the light sources can be reduced, the LDs with small maximum rated power can be used for all the colors. For example, in the case of 4-color printing, the maximum rated power of four LDs can be small. This can reduce the cost, and solve the problems of heat due to light sources with large power, the power consumption and the like.

Further, even when the LD power is restricted, the printing speed in the monochrome mode can be increased.

When the same LD is used, the wavelengths, the radiation angles and the electric rise characteristics are the approximately uniform even if the power is different, and thus the same optical parts around the light sources can be used. When the same light sources and the same optical parts are used as the peripheral parts, properties such as the beam diameters of the main and sub scanning direction, and the rise and fall characteristics at the time of light emission can be similar. As a result,the constraint of the arrangement of the parts is reduced, a degree of design freedom is improved, and the parts can be arranged the most efficient.

(2) A plurality of light sources for the monochrome printing are provided to make multibeams so that the power is secured in the conventional constitution, but in the present invention, since the maximum power can be reduced, the multibeams do not have to be used normally. Further, in the case where an LD array is used to provide multibeams for a high-resolution mode or the like, an interference between each light sources of the LD array can be reduced. Since the LD array has small intervals between light emission points, when one light emission point is driven by high power, temperature around the other light emission points is increased, and this influences the light amount from the other light emission points. As a result, it is desirable that the maximum power is suppressed as much as possible. For this reason, in the present invention, the maximum power is reduced so that the interference of the LD array can be small.

(3) Only the light sources for the color printing has high power in the conventional constitution, but in the present invention, since the maximum power can be reduced, the LDs with small maximum rated power can be used for all the colors. Even in the case where the same LDs are not used for all the colors due to various conditions, the maximum rated power of the LD for black can be reduced, thereby reducing the cost.

Ideally, [(the optical efficiency of the writing optical system for the monochrome printing)/(the optical efficiency of the writing optical system for the other color printing)≈(process speed at the time of the monochrome printing)/(process speed at the time of the multicolor printing)≈(a number at the time of the monochrome printing (PPM))/(a number at the time of the monochrome printing in the multicolor printing (PPM)]. It is desirable that one LD is used commonly as all the light sources.

As a result, the optical parts can be arranged so that the image forming characteristics of all the light beams (the beam diameter on the image surface and intensity distribution), fθ characteristics, a bow of the scanning lines, a scan mirror tilt compensation effect are in the best states in the color image forming apparatus 100. Further, the color image forming apparatus, in which the approximately same characteristics can be obtained in the monochrome printing and the color printing and the image processing is balanced, can be obtained. In the color printing, the power of the light sources to be used for the monochrome printing becomes lower than the power of the light sources for the other colors, but since the same LDs are basically used, their difference is small, and thus this does not become a problem.

1-4. (canceled)

5. A color image forming apparatus including a color mode for color printing and a monochrome mode for printing at a higher printing speed than the color mode,
wherein optical efficiency of an optical component, which guides laser beams from light sources to an image surface, is higher in an optical path of a light beam used in the monochrome mode than the optical efficiency of the other optical path of the light beam.

6. A color image forming apparatus including a color mode for color printing and a monochrome mode for printing at a higher printing speed than the color mode,
wherein mirrors, which reflect laser beams in order to guide the laser beams to optimum positions when the laser beams are guided from light sources to an image surface, are arranged so that the number of the mirrors is smaller in an optical path of a light beam for the monochrome mode than the number in the other optical path of the light beam.

7. The color image forming apparatus according to claim 6, further comprising:
a light deflecting device that deflects the laser beams;
pre-deflection optical systems that are arranged between the optical deflecting device and the light sources, respectively; and
a post-deflection optical system that is arranged between the optical deflecting device and the image surface,
wherein in the optical path of the light beam for the monochrome mode, the pre-deflection optical system does not have the mirrors, the laser beams directly enter the optical deflecting device, and the post-deflection optical system has only one mirror that bends the laser beams to the image surface.

8. The color image forming apparatus according to claim 6, wherein outputs from the light sources to be used in the color mode and an output from the light source to be used in the monochrome mode are set to be equal or approximately equal.

9. The color image forming apparatus according to claim 6, wherein an output from the light source to be used in the monochrome mode is variable and provides the same output as the other light sources in the color mode, and a maximum exposing amount is increased according to a high-speed rotation in the monochrome mode.
